(19) United States
(12) Patent Application Publication
(10) Pub. No.: US 2026/0267581 A1
(43) Pub. Date: Sep. 10, 2026

(54) KVM SWITCH, KVM SYSTEM, AND OPERATION METHOD OF KVM SWITCH

(71) Applicant: Realtek Semiconductor Corporation, Hsinchu (TW)

(72) Inventors: Chun-Chieh CHAN, Hsinchu (TW); Yinghsin LIN, Hsinchu (TW); Yu Wen LIU, Hsinchu (TW)

(21) Appl. No.: 19/448,057

(22) Filed: Jan. 13, 2026

(30) Foreign Application Priority Data
Mar. 6, 2025 (TW) 114108395

(51) Int. Cl. G06F 3/14; G06F 3/023; H04N 7/01

(52) U.S. Cl. CPC G06F 3/14; G06F 3/023; H04N 7/0117; H04N 7/013

(57) ABSTRACT

An identification circuit receives a first image signal from a first host and a second image signal from a second host, and identifies the first image signal and the second image signal to generate a first identification signal and a second identification signal. A first image signal analyzer circuit analyzes the first identification signal to generate a first analyzing signal. A second image signal analyzer circuit analyzes the second identification signal to generate a second analyzing signal. When a target signal source is the first host, an image processor circuit generates a first image stream according to the first analyzing signal for displaying on a display device. When the target signal source is the second host, the image processor circuit generates a second image stream according to the second analyzing signal for displaying on the display device.

### RELATED APPLICATIONS

This application claims priority to Taiwanese Application Serial Number 114108395, filed Mar. 06, 2025, which is herein incorporated by reference.

### BACKGROUND

### Technical Field

The present disclosure relates to keyboard-video-mouse (KVM) switch technology. More particularly, the present disclosure relates to a keyboard-video-mouse switch, a keyboard-video-mouse system, and an operation method of a keyboard-video-mouse switch with seamless switching.

### Description of Related Art

With development of technology, demand for hosts increases. For example, a user in the office can operate multiple hosts for different tasks. Alternatively, a user at home can operate multiple hosts for different entertainments.

In general, each of the hosts is configured with a keyboard, a display device, and a mouse. Therefore, when there are multiple hosts, multiple keyboards, multiple display devices, and multiple mice will occupy a large space.

### SUMMARY

Some aspects of the present disclosure are to provide a keyboard-video-mouse (KVM) switch. The keyboard-video-mouse switch includes an identification circuit, a first image signal analyzer circuit, a second image signal analyzer circuit, and an image processor circuit. The identification circuit is configured to receive a first image signal from a first host and a second image signal from a second host, and configured to identify the first image signal and the second image signal to generate a first identification signal and a second identification signal. The first image signal analyzer circuit is configured to analyze the first identification signal to generate a first analyzing signal. The second image signal analyzer circuit is configured to analyze the second identification signal to generate a second analyzing signal. When a target signal source is the first host, the image processor circuit generates a first image stream according to the first analyzing signal for displaying on a display device. When the target signal source is the second host, the image processor circuit generates a second image stream according to the second analyzing signal for displaying on the display device.

Some aspects of the present disclosure are to provide a keyboard-video-mouse system. The keyboard-video-mouse system includes an input device, a display device, a first host, a second host, and a keyboard-video-mouse switch. The keyboard-video-mouse switch is coupled to the input device, the display device, the first host, and the second host. The keyboard-video-mouse switch includes an identification circuit, a first image signal analyzer circuit, a second image signal analyzer circuit, and an image processor circuit. The identification circuit is configured to receive a first image signal from the first host and a second image signal from the second host, and configured to identify the first image signal and the second image signal to generate a first identification signal and a second identification signal. The first image signal analyzer circuit is configured to analyze the first identification signal to generate a first analyzing signal. The second image signal analyzer circuit is configured to analyze the second identification signal to generate a second analyzing signal. When a target signal source is the first host, the image processor circuit generates a first image stream according to the first analyzing signal for displaying on a display device. When the target signal source is the second host, the image processor circuit generates a second image stream according to the second analyzing signal for displaying on the display device.

Some aspects of the present disclosure are to provide an operation method of a keyboard-video-mouse switch. The operation method includes following operations: receiving, by an identification circuit in a keyboard-video-mouse switch, a first image signal from a first host and a second image signal from a second host; identifying, by the identification circuit, the first image signal and the second image signal to generate a first identification signal and a second identification signal; analyzing, by a first image signal analyzer circuit in the keyboard-video-mouse switch, the first identification signal to generate a first analyzing signal; analyzing, by a second image signal analyzer circuit in the keyboard-video-mouse switch, the second identification signal to generate a second analyzing signal; generating, by an image processor circuit in the keyboard-video-mouse switch, a first image stream according to the first analyzing signal for displaying on a display device when a target signal source is the first host; and generating, by the image processor circuit, a second image stream according to the second analyzing signal for displaying on the display device when the target signal source is the second host.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a keyboard-video-mouse (KVM) system according to some embodiments of the present disclosure.

FIG. 2 is a schematic diagram of a keyboard-video-mouse switch according to some embodiments of the present disclosure.

FIG. 3 is a sequence diagram of images in some related approaches and images in some embodiments of the present disclosure.

FIG. 4 is a schematic diagram of a keyboard-video-mouse switch according to some embodiments of the present disclosure.

FIG. 5 is a flow diagram of an operation method of a keyboard-video-mouse switch according to some embodiments of the present disclosure.

### DETAILED DESCRIPTION

In the present disclosure, "connected" or "coupled" may refer to “electrically connected” or “electrically coupled.” "Connected" or "coupled" may also refer to operations or actions between two or more elements.

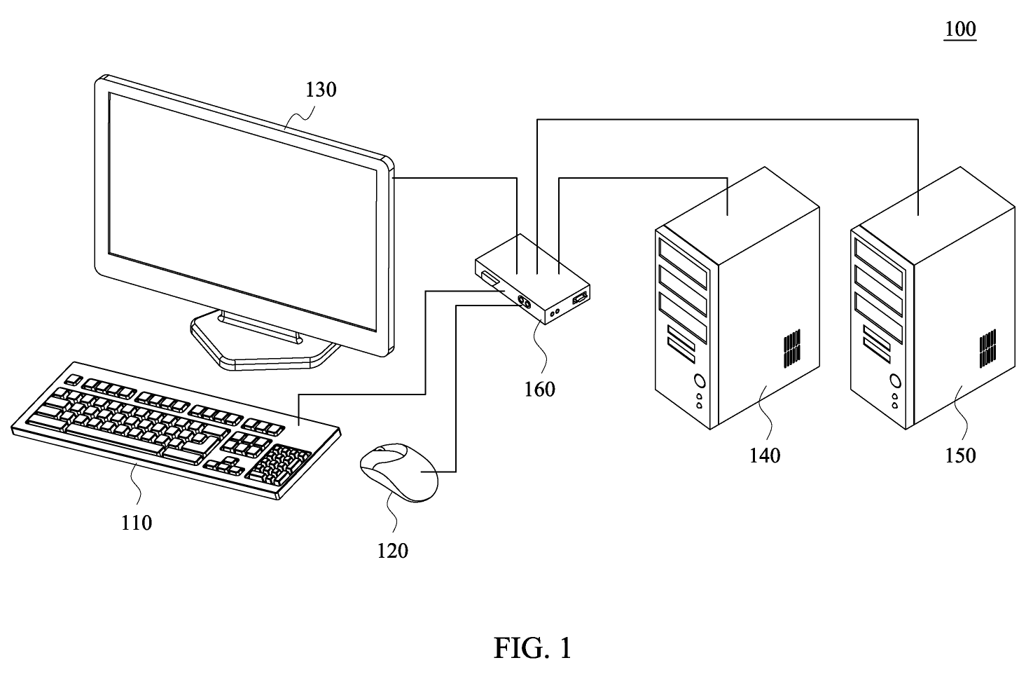

Reference is made to FIG. 1. FIG. 1 is a schematic diagram of a keyboard-video-mouse (KVM) system 100 according to some embodiments of the present disclosure.

As illustrated in FIG. 1, the keyboard-video-mouse system 100 includes an input device 110, an input device 120, a display device 130, a host 140, a host 150, and a keyboard-video-mouse switch 160.

Regarding the coupling relationship, the input device 110, the input device 120, the display device 130, the host 140, and the host 150 are coupled to the keyboard-video-mouse switch 160 respectively.

In the embodiment of FIG. 1, the input device 110 is a keyboard. The input device 120 is a mouse. The display device 130 is a display for a desktop computer. The host 140 and the host 150 are hosts for desktop computers. However, the present disclosure is not limited thereto. In other embodiments, the input device 110 or the input device 120 can be a handwriting tablet or other device with functions of inputting commands. The display device 130 can be a display for a notebook computer or other devices with functions of displaying images. The host 140 and the host 150 can also be servers or other data centers.

In actual applications, a user can operate the input device 110 or the input device 120 to switch between the host 140 and the host 150 through the keyboard-video-mouse switch 160. When the user uses the keyboard-video-mouse switch 160 to connect the host 140, the display device 130 displays the video stream from the host 140. When the user uses the keyboard-video-mouse switch 160 to connect the host 150, the display device 130 displays the video stream from the host 150. Accordingly, the user can switch work items of different hosts without moving its position to saving moving and physical efforts. At the same time, it can improve work efficient, increase productivity, simplify management, save work time and save workload. In addition, since the host 140 and the host 150 share the input device 110, the input device 120, and the display device 130, this can save equipment costs and make the working environment more concise.

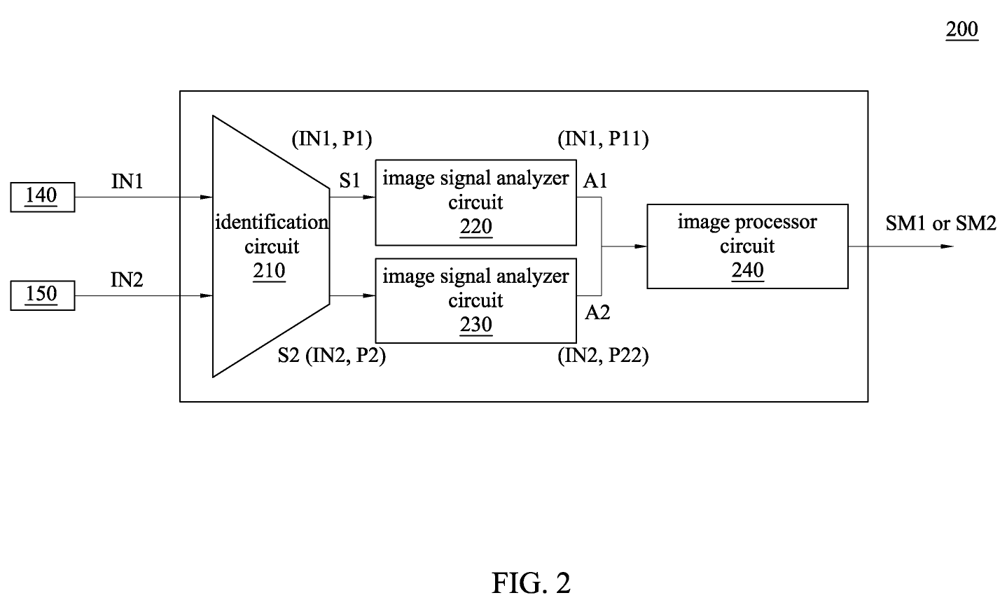

Reference is made to FIG. 2. FIG. 2 is a schematic diagram of a keyboard-video-mouse switch 200 according to some embodiments of the present disclosure. In some embodiments, the keyboard-video-mouse switch 200 can be used to implement the keyboard-video-mouse switch 160 in FIG. 1.

As illustrated in FIG. 2, the keyboard-video-mouse switch 200 includes an identification circuit 210, an image signal analyzer circuit 220, an image signal analyzer circuit 230, and an image processor circuit 240.

Regarding the coupling relationship, the identification circuit 210 is coupled to the image signal analyzer circuit 220 and the image signal analyzer circuit 230. The image signal analyzer circuit 220 and the image signal analyzer circuit 230 are coupled to the image processor circuit 240. In some embodiments, the circuit structure of the image signal analyzer circuit 230 is same to the circuit structure of the image signal analyzer circuit 220.

The identification circuit 210 can receive an image signal IN1 and an image signal IN2 from the host 140 and the host 150 respectively. In some embodiments, the signal type of the image signal IN1 is different from the signal type of the image signal IN2. In some embodiments, the signal type of the image signal IN1 is same to the signal type of the image signal IN2. For example, the signal type of the image signal IN1 or the image signal IN2 is High Definition Multimedia Interface (HDMI), Display Port (DP), Video Graphics Array (VGA), or other specifications.

The identification circuit 210 can identify the signal type of the image signal IN1 and the signal type of the image signal IN2, and further identify an image related parameter P1 of the image signal IN1 and an image related parameter P2 of the image signal IN2 to generate an identification signal S1 and an identification signal S2.

For example, when the image signal IN1 from an input port of DP, the signal type of the image signal IN1 is DP. When the image signal IN2 is from an input port of HDMI, the signal type of the image signal IN2 is HDMI.

In addition, it is assumed that the image signal IN1 corresponds to DP specification. Packets of the image signal IN1 at least include audio, image data, synchronization signals, control signals, and so on. The identification circuit 210 can identify the image related parameter P1 of the image signal IN1 according to specific symbols in the packets of the image signal IN1. The image related parameter P1 is, for example, a resolution and a frame rate of the image signal IN1. In some embodiments, the image related parameter P1 can be pre-stored in the register in the identification circuit 210. The image signal IN1 and the image related parameter P1 can form the identification signal S1.

Similarly, the image related parameter P2 is, for example, a resolution and a frame rate of the image signal IN2. In some embodiments, the image related parameter P2 can also be pre-stored in the register in the identification circuit 210. The image signal IN2 and the image related parameter P2 can form the identification signal S2.

The image signal analyzer circuit 220 can receive the identification signal S1 and analyze the identification signal S1 to generate an analyzing signal A1. While the image signal analyzer circuit 220 receives the identification signal S1 and analyzes the identification signal S1, the image signal analyzer circuit 230 can receive the identification signal S2 and analyze the identification signal S2 to generate an analyzing signal A2 at the same time. In other words, the image signal analyzer circuit 220 and the image signal analyzer circuit 230 can process the identification signal S1 and the identification signal S2 respectively and in parallel.

Taking the image signal analyzer circuit 220 as an example, the image signal analyzer circuit 220 can analyze the image signal IN1 in the identification signal S1 again to generate the image related parameter P11 of the image signal IN1. The image related parameter P11 is, for example, a resolution and a frame rate of the image signal IN1. For example, the image signal IN1 includes multiple frames, and each frame includes multiple lines. The image signal analyzer circuit 220 can utilize a specific clock to measure a quantity of sampling points, and then utilize corresponding formula to calculate the resolution and the frame rate of the image signal IN1. In some embodiments, the image related parameter P11 can be pre-stored in the register in the image signal analyzer circuit 220. The image signal IN1 and the image related parameter P11 can form the analyzing signal A1.

It is particularly noted that although the identification circuit 210 has identified the image related parameter P1 of the image signal IN1, the image signal analyzer circuit 220 analyzes the image related parameter P11 of the image signal IN1 again so as to achieve the purpose of double checking and continuously detecting whether the signals are stable. In some embodiments, the image related parameter P11 can be adjusted according to the image related parameter P1 based on comparison, debugging, weight, or priority determination procedure.

In addition, the image signal analyzer circuit 220 can further analyze the data format of the image related parameter P11 and convert it into a data format that can be recognized by image processor circuit 24 so as to complete the data compatibility processing.

Similarly, the image signal analyzer circuit 230 can analyze the image signal IN2 in the identification signal S2 again to generate the image related parameter P22 of the image signal IN2. The image related parameter P22 is, for example, a resolution and a frame rate of the image signal IN2. In some embodiments, the image related parameter P22 can be adjusted according to the image related parameter P2 based on comparison, debugging, weight, or priority determination procedure. In some embodiments, the image related parameter P22 can be pre-stored in the register in the image signal analyzer circuit 230. The image signal IN2 and the image related parameter P22 can form the analyzing signal A2. The image signal analyzer circuit 230 can also perform the data compatibility processing described above.

In some embodiments, the image signal analyzer circuit 220 and the image signal analyzer circuit 230 can continuously detect or check whether the image signal IN1 and the image signal IN2 transmitted from the identification circuit 210 have data errors or data loss in the background.

It is assumed that the default target signal source is the host 140 (the image signal IN1 carries information that it is the target signal source). At this time, the image processor circuit 240 can generate the image stream SM1 according to the analyzing signal A1 for the display device 130 to display. To be more specific, the image processor circuit 240 can receive the analyzing signal A1 (including the current image signal IN1 and the pre-generated image related parameter P11) from the image signal analyzer circuit 220 and performs the image processing procedure on the analyzing signal A1 to generate the image stream SM1. Then, the image processor circuit 240 can transmit the image stream SM1 to the display device 130 for the display device 130 to display. The image processing procedure herein is, for example, resolution conversion, frame rate conversion, color correction, or other image processing.

When the use presses a button corresponding to the host 150 on the keyboard-video-mouse switch 160, the target signal source is switched to the host 150 from the host 140 (e.g., the image signal IN2 carries information that it is the target signal source). Then, the image processor circuit 240 can generate an image stream SM2 according to the analyzing signal A2 for the display device 130 to display. To be more specific, the image processor circuit 240 can receive the analyzing signal A2 (including the current image signal IN2 and the pre-generated image related parameter P22) from the image signal analyzer circuit 230 rapidly and perform the image processing procedure on the analyzing signal A2 to generate the image stream SM2. Then, the image processor circuit 240 can transmit the image stream SM2 to the display device 130 for the display device 130 to display.

However, after the target signal source is switched to the host 150 from the host 140, the image signal analyzer circuit 220 still continues to receive and analyze the identification signal S1, and stores the image related parameter P11 (e.g., the updated resolution and the updated frame rate) of the image signal IN1 in advance. Thus, when the target signal source is switched to the host 140 again, the image processor circuit 240 can receive the new analyzing signal A1 (including the current image signal IN1 and the pre-generated and updated image related parameter P11) from the image signal analyzer circuit 220 rapidly, and perform the image processing procedure on the new analyzing signal A1 to generate a new image stream SM1.

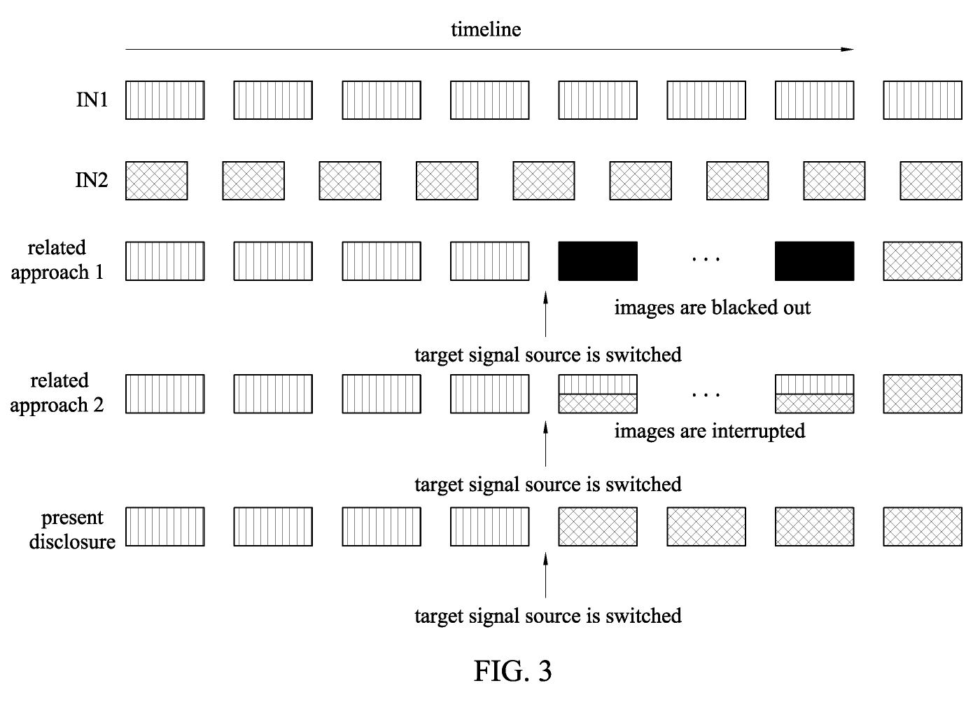

Reference is made to FIG. 3. FIG. 3 is a sequence diagram of images in some related approaches and images in some embodiments of the present disclosure.

In some related approaches about keyboard-video-mouse switches, only one image signal analyzer circuit is disposed in the keyboard-video-mouse switch. This image signal analyzer circuit merely analyzes one image signal (e.g., the image signal IN1). When the target signal source is switched, this image signal analyzer circuit then analyzes another image signal (e.g., the image signal IN2). Since the analysis procedure takes a lot of time, the image signal analyzer circuit cannot output another image stream (e.g., the image stream SM2) in real time. Accordingly, it can cause image blackout or interrupt on the display device 130.

As illustrated in FIG. 3, in the related approach 1, the images on the display device 130 are blacked out. In the related approach 2, the images on the display device 130 are interrupted. These results in a bad viewing experience for users.

Compared to the aforementioned related approaches, the keyboard-video-mouse switch 200 in the present disclosure is designed with two (or more) image signal analyzer circuits 220 and 230. Accordingly, while the image signal analyzer circuit 220 analyzes the identification signal S1, the image signal analyzer circuit 230 can analyze the identification signal S2 at the same time to generate the image related parameter P22 of the image signal IN2 in advance. When the target signal source is switched, the image processor circuit 240 can receive the analyzing signal A2 (including the current image signal IN2 and the pre-generated image related parameter P22) rapidly to instantly output the image stream SM2 instead of the image stream SM1 so as to shorten the processing time and reduce the switching delay to achieve seamless switching and improve user’s viewing experience.

In some embodiments, the image processor circuit 240 generates the corresponding image stream SM1 or the corresponding image stream SM2 according to the resolution and the frame rate of the display device 130. It is assumed that the image signal IN1 or the image signal IN2 corresponds to a first resolution and a first frame rate. When the display device 130 has an image output ability with a second resolution and a second frame rate, the image processor circuit 240 performs the image processing procedure on the analyzing signal A1 or the analyzing signal A2 to generate the image stream SM1 or the image stream SM2 with the second resolution and the second frame rate for the display device 130 to display. For example, it is assumed that a resolution of the image signal IN1 is 1080P and a frame rate of the image signal IN1 is 75 Hz. When the resolution of the display device 130 is 4K and the frame rate of the display device 130 is 60 Hz, the image processor circuit 240 generates the image stream SM1 with the 4K resolution and 60 Hz frame rate. It is assumed that a resolution of the image signal IN2 is 4K and a frame rate of the image signal IN2 is 60 Hz. When the resolution of the display device 130 is 4K and the frame rate of the display device 130 is 60 Hz, the image processor circuit 240 generates the image stream SM2 with the 4K resolution and 60 Hz frame rate for the display device 130 to display. Accordingly, even if user switches the target signal sources, the display device 130 can still maintain the same image quality to improve user’s viewing experience.

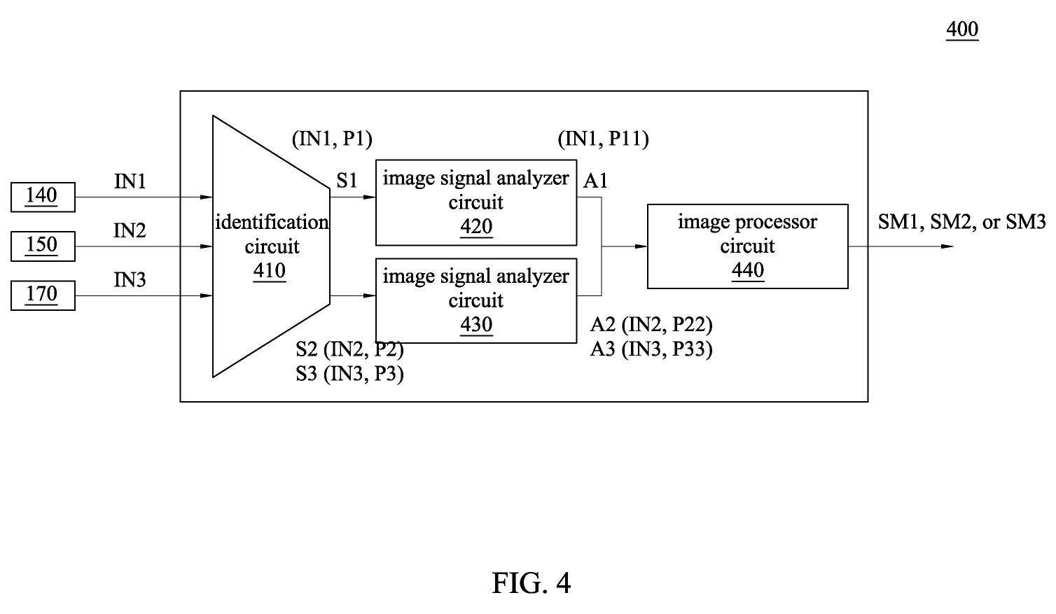

Reference is made to FIG. 4. FIG. 4 is a schematic diagram of a keyboard-video-mouse switch 400 according to some embodiments of the present disclosure. In some embodiments, the keyboard-video-mouse switch 400 can be used to implement the keyboard-video-mouse switch 160 in FIG. 1.

The circuit structure of the keyboard-video-mouse switch 400 is similar to the circuit structure if the keyboard-video-mouse switch 200 in FIG. 2. One major difference between the keyboard-video-mouse switch 400 and the keyboard-video-mouse switch 200 is that, an identification circuit 410 can further receive an image signal IN3 from a host 170. In some embodiments, the signal type of the image signal IN3 is different from the signal type of the image signal IN1 or the signal type of the image signal IN2. In some embodiments, the signal type of the image signal IN3 is same to the signal type of the image signal IN1 and the signal type of the image signal IN2. The identification circuit 410 can identify the signal type of the image signal IN3, and further identify an image related parameter P3 of the image signal IN3 to generate an identification signal S3.

The method of the identification circuit 410 identifying the image signal IN3 is similar to the method of the identification circuit 210 identifying the image signal IN1 above, so it is not described herein again.

Similarly, while an image signal analyzer circuit 420 receives the identification signal S1 and analyzes the identification signal S1, an image signal analyzer circuit 430 can analyze the identification signal S2 and the identification signal S3 at the same time to generate the analyzing signal A2 and an analyzing signal A3.

The method of the image signal analyzer circuit 430 analyzing the identification signal S2 and the identification signal S3 is similar to the method of the image signal analyzer circuit 220 analyzing the identification signal S1, so it is not described herein again.

In some embodiments, the image signal analyzer circuit 430 analyzes the identification signal S2 and the identification signal S3 simultaneously. In some embodiments, after the image signal analyzer circuit 430 analyzes the identification signal S2, the image signal analyzer circuit 430 then analyzes the identification signal S3. In some embodiments, the image signal analyzer circuit 430 analyzes the identification signal S2 and the identification signal S3 in rotation.

As described above, in some embodiments, the image signal analyzer circuit 420 and the image signal analyzer circuit 430 can also continuously detect or check the image signal IN1, the image signal IN2, and the image signal IN3 transmitted from the identification circuit 410 in the background to determine whether there is any data error or any data loss.

When the user presses a button corresponding to the host 170 on the keyboard-video-mouse switch 160, the target signal source is switched to the host 170 (the image signal IN3 carries information that it is the target signal source). Then, the image processor circuit 440 can receive the analyzing signal A3 (including current image signal IN3 and the pre-generated image related parameter P33) from the image signal analyzer circuit 430 rapidly and perform the image processing procedure on the analyzing signal A3 to generate an image stream SM3. Then, the image processor circuit 440 can transmit the image stream SM3 to the display device 130 for the display device 130 to display.

Compared to the keyboard-video-mouse switch 200 in FIG. 2, the keyboard-video-mouse switch 400 can achieve seamless switching between more signal sources.

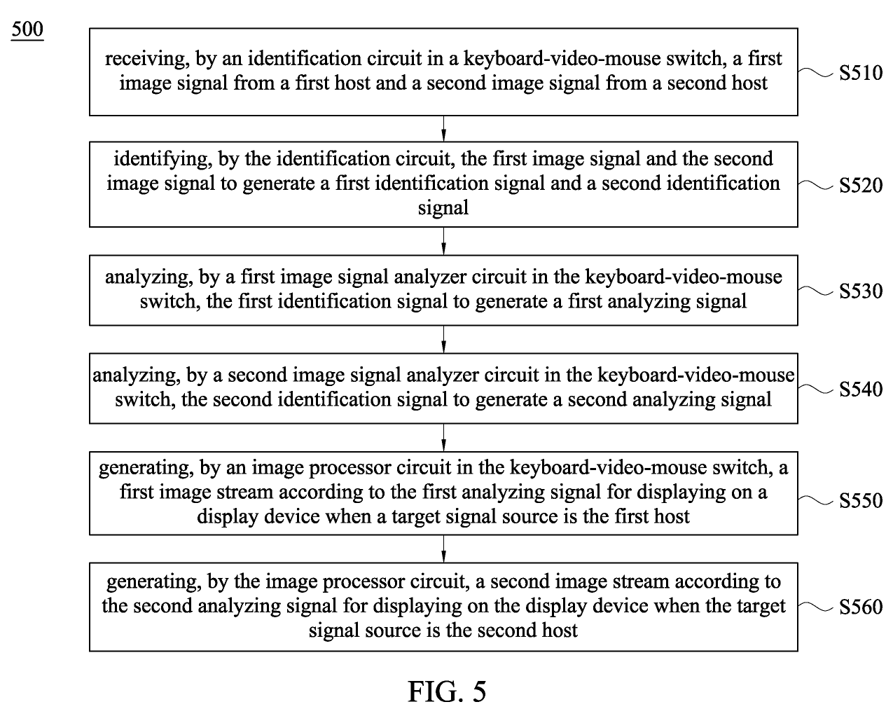

Reference is made to FIG. 5. FIG. 5 is a flow diagram of an operation method 500 of a keyboard-video-mouse switch according to some embodiments of the present disclosure.

As illustrated in FIG. 5, the operation method 500 includes operation S510, operation S520, operation S530, operation S540, operation S550, and operation S560.

In some embodiments, the operation method 500 can be implemented to the keyboard-video-mouse switch 200 in FIG. 2 or the keyboard-video-mouse switch 400 in FIG. 4.

For better understanding, the operation method 500 is described in following paragraphs with reference to FIG. 1 and the keyboard-video-mouse switch 200 in FIG. 2.

In operation S510, the identification circuit 210 in the keyboard-video-mouse switch 160 receives the image signal IN1 from the host 140 and the image signal IN2 from the host 150.

In operation S520, the identification circuit 210 identifies the image signal IN1 and the image signal IN2 to generate the identification signal S1 and the identification signal S2.

In operation S530, the image signal analyzer circuit 220 in the keyboard-video-mouse switch 200 analyzes the identification signal S1 to generate the analyzing signal A1.

In operation S540, the image signal analyzer circuit 230 in the keyboard-video-mouse switch 200 analyzes the identification signal S2 to generate the analyzing signal A2.

In operation S550, when the target signal source is the host 140, the image processor circuit 240 in the keyboard-video-mouse switch 200 generates the image stream SM1 according to the analyzing signal A1 for displaying on the display device 130. To be more specific, the image processor circuit 240 in the keyboard-video-mouse switch 200 receives the analyzing signal A1 and performs the image processing procedure on the analyzing signal A1 to generate the image stream SM1 and the display device 130 displays the image stream SM1.

In operation S560, when the target signal source is switched to the host 150from the host 140, the image processor circuit 240 in the keyboard-video-mouse switch 200 generates the image stream SM2 according to the analyzing signal A2 for displaying on the display device 130. To be more specific, the image processor circuit 240 in the keyboard-video-mouse switch 200 receives the analyzing signal A2 and performs the image processing procedure on the analyzing signal A2 to generate the image stream SM2 and the display device 130 displays the image stream SM2.

The details of these operations are described in the embodiments above, so they are not described herein again.

As described above, the keyboard-video-mouse switch in the present disclosure is provided with two (or more) image analyzer circuits. Accordingly, when the target signal source changes, the image processor circuit can output the new image stream to the display device in real time to shorten the processing time and reduce the switching delay to achieve seamless switching and improve user’s viewing experience.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A keyboard-video-mouse (KVM) switch, comprising:
an identification circuit configured to receive a first image signal from a first host and a second image signal from a second host, and configured to identify the first image signal and the second image signal to generate a first identification signal and a second identification signal;
a first image signal analyzer circuit configured to analyze the first identification signal to generate a first analyzing signal;
a second image signal analyzer circuit configured to analyze the second identification signal to generate a second analyzing signal; and
an image processor circuit,
wherein when a target signal source is the first host, the image processor circuit generates a first image stream according to the first analyzing signal for displaying on a display device,
wherein when the target signal source is the second host, the image processor circuit generates a second image stream according to the second analyzing signal for displaying on the display device.

2. The keyboard-video-mouse switch of claim 1, wherein while the first image signal analyzer circuit analyzes the first identification signal, the second image signal analyzer circuit analyzes the second identification signal.

3. The keyboard-video-mouse switch of claim 2, wherein the second image signal analyzer circuit is further configured to store at least one image related parameter in the second analyzing signal, wherein the at least one image related parameter comprises a resolution of the second image signal and a frame rate of the second image signal.

4. The keyboard-video-mouse switch of claim 1, wherein when the first image signal or the second image signal corresponds to a first resolution and a first frame rate and the display device corresponds to a second resolution and a second frame rate, the image processor circuit generates the first image stream or the second image stream corresponding to the second resolution and the second frame rate for displaying on the display device.

5. The keyboard-video-mouse switch of claim 1, wherein the identification circuit is further configured to receive a third image signal from a third host, and identify the third image signal to generate a third identification signal,
wherein the second image signal analyzer circuit is further configured to analyze the third identification signal to generate a third analyzing signal and store at least one image related parameter in the third analyzing signal, wherein the at least one image related parameter comprises a resolution of the third image signal and a frame rate of the third image signal.

6. The keyboard-video-mouse switch of claim 5, wherein the second image signal analyzer circuit analyzes the second identification signal and the third identification signal in rotation.

7. The keyboard-video-mouse switch of claim 1, wherein the first image signal corresponds to a first signal type, the second image signal corresponds to a second signal type, and the second signal type is different from the first signal type.

8. A keyboard-video-mouse (KVM) system, comprising:
an input device;
a display device;
a first host;
a second host; and
a keyboard-video-mouse switch coupled to the input device, the display device, the first host, and the second host, wherein the keyboard-video-mouse switch comprises:
an identification circuit configured to receive a first image signal from the first host and a second image signal from the second host, and configured to identify the first image signal and the second image signal to generate a first identification signal and a second identification signal;
a first image signal analyzer circuit configured to analyze the first identification signal to generate a first analyzing signal;
a second image signal analyzer circuit configured to analyze the second identification signal to generate a second analyzing signal; and
an image processor circuit,
wherein when a target signal source is the first host, the image processor circuit generates a first image stream according to the first analyzing signal for displaying on the display device,
wherein when the target signal source is the second host, the image processor circuit generates a second image stream according to the second analyzing signal for displaying on the display device.

9. The keyboard-video-mouse system of claim 8, wherein while the first image signal analyzer circuit analyzes the first identification signal, the second image signal analyzer circuit analyzes the second identification signal.

10. The keyboard-video-mouse system of claim 9, wherein the second image signal analyzer circuit is further configured to store at least one image related parameter in the second analyzing signal, wherein the at least one image related parameter comprises a resolution of the second image signal and a frame rate of the second image signal.

11. The keyboard-video-mouse system of claim 8, wherein when the first image signal or the second image signal corresponds to a first resolution and a first frame rate and the display device corresponds to a second resolution and a second frame rate, the image processor circuit generates the first image stream or the second image stream corresponding to the second resolution and the second frame rate for displaying on the display device.

12. The keyboard-video-mouse system of claim 8, wherein the identification circuit is further configured to receive a third image signal from a third host, and identify the third image signal to generate a third identification signal,
wherein the second image signal analyzer circuit is further configured to analyze the third identification signal to generate a third analyzing signal and store at least one image related parameter in the third analyzing signal, wherein the at least one image related parameter comprises a resolution of the third image signal and a frame rate of the third image signal.

13. The keyboard-video-mouse system of claim 12, wherein the second image signal analyzer circuit analyzes the second identification signal and the third identification signal in rotation.

14. The keyboard-video-mouse system of claim 8, wherein the first image signal corresponds to a first signal type, the second image signal corresponds to a second signal type, and the second signal type is different from the first signal type.

15. An operation method of a keyboard-video-mouse (KVM) switch, comprising:
receiving, by an identification circuit in a keyboard-video-mouse switch, a first image signal from a first host and a second image signal from a second host;
identifying, by the identification circuit, the first image signal and the second image signal to generate a first identification signal and a second identification signal;
analyzing, by a first image signal analyzer circuit in the keyboard-video-mouse switch, the first identification signal to generate a first analyzing signal;
analyzing, by a second image signal analyzer circuit in the keyboard-video-mouse switch, the second identification signal to generate a second analyzing signal;
generating, by an image processor circuit in the keyboard-video-mouse switch, a first image stream according to the first analyzing signal for displaying on a display device when a target signal source is the first host; and
generating, by the image processor circuit, a second image stream according to the second analyzing signal for displaying on the display device when the target signal source is the second host.

16. The operation method of the keyboard-video-mouse switch of claim 15, further comprising:
while the first image signal analyzer circuit analyzes the first identification signal, analyzing, by the second image signal analyzer circuit, the second identification signal and storing, by the second image signal analyzer circuit, at least one image related parameter in the second identification signal,
wherein the at least one image related parameter comprises a resolution of the second image signal and a frame rate of the second image signal.

17. The operation method of the keyboard-video-mouse switch of claim 15, further comprising:
when the first image signal or the second image signal corresponds to a first resolution and a first frame rate and the display device corresponds to a second resolution and a second frame rate, generating, by the image processor circuit, the first image stream or the second image stream corresponding to the second resolution and the second frame rate for displaying on the display device.

18. The operation method of the keyboard-video-mouse switch of claim 15, further comprising:
receiving, by the identification circuit, a third image signal from a third host;
identifying, by the identification circuit, the third image signal to generate a third identification signal; and
analyzing, by the second image signal analyzer circuit, the third identification signal to generate a third analyzing signal and storing, by the second image signal analyzer circuit, at least one image related parameter in the third analyzing signal,
wherein the at least one image related parameter comprises a resolution of the third image signal and a frame rate of the third image signal.

19. The operation method of the keyboard-video-mouse switch of claim 18, wherein the second image signal analyzer circuit analyzes the second identification signal and the third identification signal in rotation.

20. The operation method of the keyboard-video-mouse switch of claim 15, wherein the first image signal corresponds to a first signal type, the second image signal corresponds to a second signal type, and the second signal type is different from the first signal type.
